(19) United States
(12) Patent Application Publication
(10) Pub. No.: US 2006/0206430 A1
(43) Pub. Date: Sep. 14, 2006

(54) Software management system, software management method, and computer product

(75) Inventors: Hiroshi Murata, Kawasaki (JP); Nobuyuki Yamazaki, Kawasaki (JP); Yasuaki Morita, Kawasaki (JP); Kazumasa Matano, Kawasaki (JP); Katuyoshi Eguchi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/214,870

(22) Filed: Aug. 31, 2005

(30) Foreign Application Priority Data
Mar. 14, 2005 (JP) 2005-072098

(51) Int. Cl. G06F 17/60

(52) U.S. Cl. 705/51

(57) ABSTRACT

A software management system includes a receiving unit that receives inspection information that indicates whether each of software components registered within a predetermined period has passed or failed in an inspection; a detecting unit that detects a software component that has failed in the inspection based on the inspection information; a determining unit that determines whether a revised version of the software component detected is registered after the predetermined period; and an output unit that outputs information indicating that at least such software components are permitted to be packaged that have passed the inspection, based on determination by the determining unit.

### CROSS-REFERENCE TO RELATED APPLICATIONS

This application is based upon and claims the benefit of priority from the prior Japanese Patent Application No. 2005-072098, filed on Mar. 14, 2005, the entire contents of which are incorporated herein by reference.

### BACKGROUND OF THE INVENTION

1. Field of the Invention

The present invention relates to a software management system and a software management method for managing software components to form a software package, and a computer product.

2. Description of the Related Art

Conventionally, in providing software such as product software, software components registered at a software provider end are packaged into a software package to be downloaded at a user end. When a software package is downloaded, transmission of files in the software package or the files themselves are monitored by performing a transmission control based on, for example, difference in volume between files transmitted from the software provider and files received by the user (for example, Japanese Patent No. 3296570), or by extracting a file of a different generation, which is a current generation, based on a generation-management master in a data file (for example, Japanese Patent Application Laid-Open Publication No. H10-240594).

Generally the software package includes thousands of files and has a total amount of several gigabytes (GB). This results in a long transmission time and a heavy load on a network. Such a great number and a great volume of the files also make a file management process complex. Especially because a process of packaging the software components is performed manually, for example, a software component that has failed in an inspection before shipment can be included in the software package. Such software package results in a faulty software package and requires additional work for transferring files to change the package software for revising faulty files over the network, or for managing the software package before and after revision. Thus, it is difficult to build a management system adequate in terms of quality management of software package with the conventional technologies.

### SUMMARY OF THE INVENTION

It is an object of the present invention to solve at least the above problems in the conventional technology.

A software management system according to one aspect of the present invention includes a receiving unit that receives inspection information that indicates a result of inspection carried out on a plurality of software components registered within a predetermined period, the inspection information indicating whether each of the software components has passed or failed in the inspection; a detecting unit that detects a software component that has failed in the inspection based on the inspection information from among the software components registered; a determining unit that determines whether a revised version of the software component detected is registered after the predetermined period; and an output unit that outputs information indicating that at least such software components are permitted to be packaged that correspond to inspection information indicating that the software components have passed the inspection, based on determination by the determining unit.

A software management method according to another aspect of the present invention includes receiving inspection information that indicates a result of inspection carried out on a plurality of software components registered within a predetermined period, the inspection information indicating whether each of the software components has passed or failed in the inspection; detecting a software component that has failed in the inspection based on the inspection information from among the software components registered; determining whether a revised version of the software component detected is registered after the predetermined period; and outputting information indicating that at least such software components are permitted to be packaged that correspond to inspection information indicating that the software components have passed the inspection, based on determination at the determining.

A computer-readable recording medium according to still another aspect of the present invention stores a software management program for realizing a software management method according to the above aspects.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a system configuration of a software management system according to an embodiment of the present invention;

FIG. 2 is a schematic of a hardware configuration of a software management server in the software management system;

FIG. 3 is a block diagram of a functional configuration of the software management server;

FIG. 4 is a flowchart of a software management process according to an embodiment of the present invention;

FIG. 5 is a schematic for illustrating a software-management time cycle of the software management system;

FIG. 6 is a schematic for illustrating an entire process of the software management process;

FIG. 7 is a schematic for illustrating a time-cycle management table used in the software management system;

FIG. 8 is a schematic for illustrating a program-packaging m management table used in the software management system;

FIG. 9 is a schematic for illustrating a packaging-category management table used in the software management system;

FIG. 10 is a flowchart of a program checking process according to an embodiment of the present invention; and

FIG. 11 is a schematic for illustrating a program-check-result management table used in the software management system according to an embodiment of the present invention.

### DETAILED DESCRIPTION OF THE PREFERRED EMBODIMENTS

Exemplary embodiments of the present invention will be explained in detail below with reference to the accompanying drawings. A software management system, a software management method, a software management program, and a recording medium according to the embodiments can be realized by, for example, a computer system provided with a recording medium on which the computer program according to the embodiments is recorded.

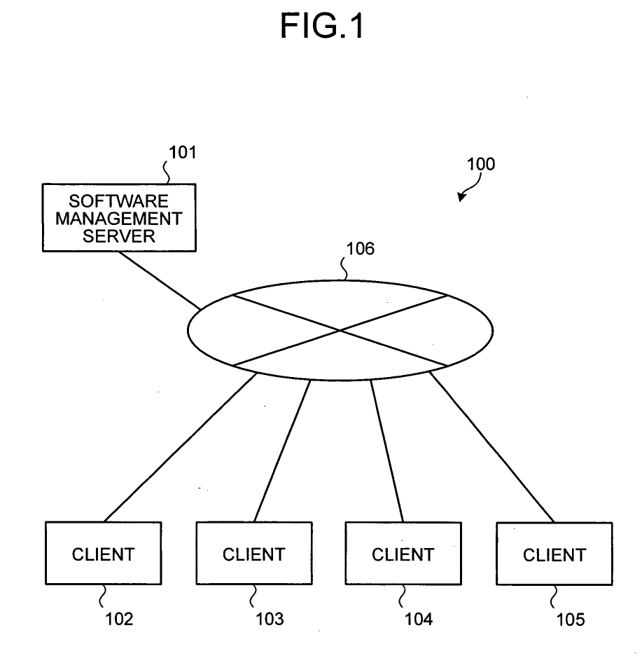

FIG. 1 is a block diagram of a system configuration of a software management system according to an embodiment of the present invention. As shown in FIG. 1, a software management system 100 includes a software management server 101 and clients 102 to 105. The software management server 101 is connected to each of the clients 102 to 105 via a network 106, enabling interactive communication. The software management server 101 functions as a provider of package file in which plural software components are packaged to the clients 102 to 105, and each of the clients 102 to 105 functions as a user of the package file. The software components specifically are programs or libraries that cause hardware to operate. Software specifically refers to a product in which the software components are assembled.

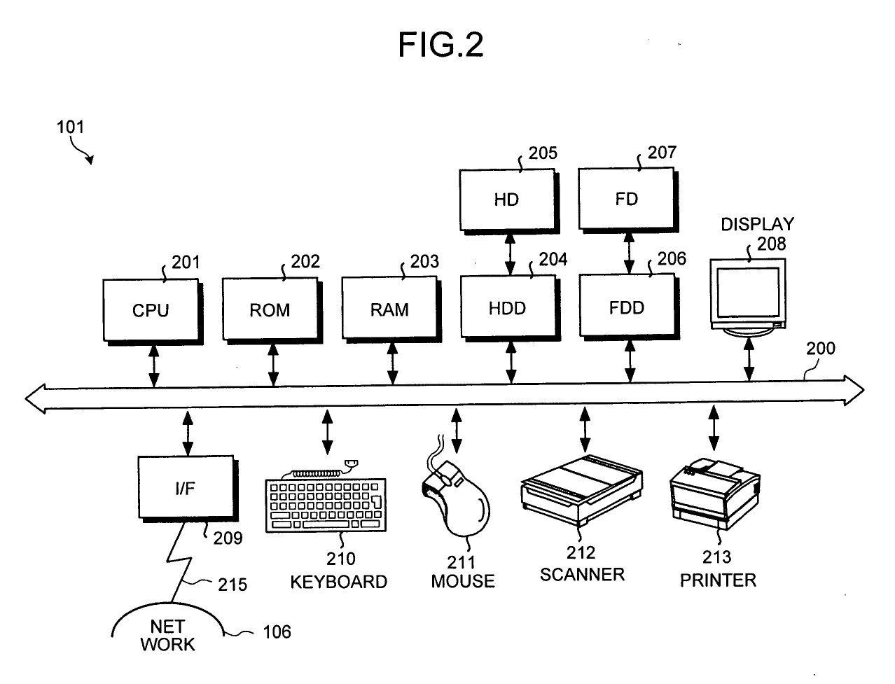

FIG. 2 is a schematic of a hardware configuration of the software management server 101. Each of the clients 102 to 105 shown in FIG. 1 may have the same hardware configuration as the software management server 101.

The software management server 101 includes a central processing unit (CPU) 201, a read-only memory (ROM) 202, a random access memory (RAM) 203, a hard disk drive (HDD) 204, a hard disk (HD) 205, a flexible disk drive (FDD) 206, a flexible disk (FD) 207 as an example of a removable recording medium, a display 208, an interface (I/F) 209, a keyboard 210, a mouse 211, a scanner 212, and a printer 213. A bus 200 connects all the aforementioned devices.

The CPU 201 controls a whole of the software management server 101. The ROM 202 stores a computer program such as a boot program. The RAM 203 is used as a work area of the CPU 201. The HDD 204 controls read/write of data from/to the HD 205 in accordance with the control of the CPU 201. The HD 205 stores data that is written in accordance with the control of the HDD 204.

The FDD 206 controls read/write of data from/to the FD 207 in accordance with the control of the CPU 201. The FD 207 stores data that is written by a control of the FDD 206 and lets the apparatus read the data stored in the FD 207.

Apart from the FD 207, a compact disc-read only memory (CD-ROM), a compact disc-readable (CD-R), a compact disc-rewritable (CD-RW), a magnetic optical disc (MO), a digital versatile disc (DVD), and a memory card may also be used as the removable recording medium. The display 208 displays a curser, an icon, a tool box as well as data such as documents, images, and functional information. A cathode ray tube (CRT), a thin film transistor (TFT) liquid crystal display, or a plasma display can be used as the display 208.

The I/F 209 is connected to the network 106 such as the Internet through a communication line and is connected to other devices through the network 106. The I/F 209 controls the network 106 and an internal interface to control input/output of data to/from external devices. A modem or a local area network (LAN) adapter can be used as the I/F 209.

The keyboard 210 includes keys for inputting characters, numbers, and various instructions, and is used to input data. A touch panel input pad or a numerical key pad may also be used as the keyboard 210. The mouse 211 is used to shift the curser, select a range, shift windows, and change sizes of the windows on a display. A track ball or a joy stick may be used as a pointing device if functions similar to those of the mouse 211 are provided.

The scanner 212 optically captures an image and inputs image data to the apparatus. The scanner 212 may be provided with an optical character read (OCR) function. The printer 213 prints the image data and document data. For example, a laser printer or an inkjet printer may be used as the printer 213.

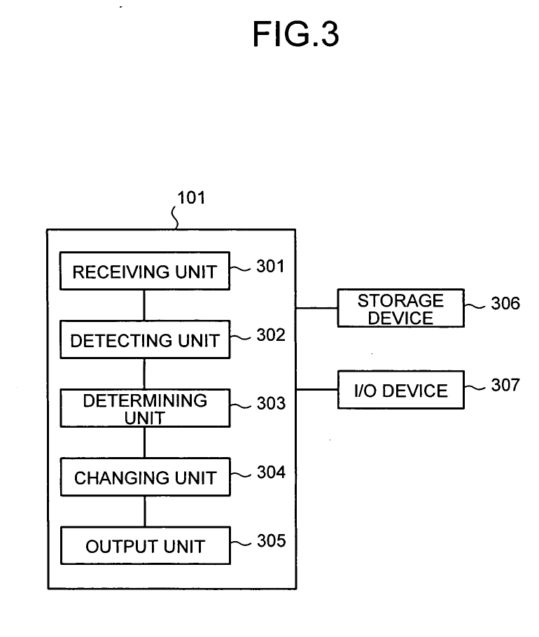

FIG. 3 is a block diagram of a functional configuration of the software management server 101. As shown in FIG. 3, the software management server 101 includes a receiving unit 301, a detecting unit 302, a determining unit 303, a changing unit 304, and an output unit 305. The software management server 101 is connected to a storage device 306 and an input/output (I/O) device 307. The software management server 101 performs software management process, for example, according to a software management program stored in the storage device 306.

The receiving unit 301 receives inspection-result information indicating results of inspection of software components that are registered in the software management system 100 (see FIG. 1) within a predetermined period. The predetermined period is a period for packaging the software components. The inspection-result information is identification information (flag) that indicates whether a software component has passed or failed in an inspection before shipment. Specifically, functions of the receiving unit 301 is realized by the I/F 209 shown in FIG. 2.

The detecting unit 302 detects a software component that has failed in the inspection from among the software components registered. Such detection is carried out by detecting inspection-result information in which failure in the inspection is flagged, and then, by detecting the software component that corresponds to the inspection-result information detected. Specifically, functions of the detecting unit 302 is realized by the CPU 201 executing the program recorded on a recording medium such as the ROM 202, the RAM 203, the HD 205, and the FD 207.

The determining unit 303 determines whether a revised version of the software component detected is registered in the software management system 100 after the predetermined period. The determination process involves consistency check (by checking whether a date stamp at the time of registration, inspection-result information, a software component name, a version number of the software component, etc. are consistent) of the software component detected and a revised version of the software component. When consistency is assured, it is determined whether the software component is registered within the predetermined period or after the predetermined period based on a date stamp of the revised version. Specifically, functions of the determining unit 303 are realizes by the CPU 201 executing a program recorded on a recording medium such as the ROM 202, the RAM 203, the HD 205, and the FD 207 shown in FIG. 2.

When the determining unit 303 determines that the revised version of the software component is registered in the software management system 100 after the predetermined period, the changing unit 304 changes a status in the inspection-result information of the software component detected from a failed status to a cleared status. Specifically, functions of the changing unit 304 are realized by the CPU 201 executing a computer program recorded on a recording medium such as the ROM 202, the RAM 203, the HD 205, and the FD 207 shown in FIG. 2.

The output unit 305 outputs, based on a result of determination by the determining unit 303, information that indicates that at least such software components may be packaged that corresponds to the inspection-result information indicating that the software components have passed the inspection. Furthermore, when the status in the inspection-result information of the software component of which the revised version is registered is changed, the output unit 305 outputs information that indicates that the revised version of the software component may be packaged as well as the software components that corresponds to the inspection-result information indicating that the software components have passed the inspection.

If the determining unit 303 determines that the revised version is not registered in the software management system 100, the output unit 305 outputs information that indicates that the software components may not be packaged. Specifically, in the output unit 305, a function of generating the information to permit packaging is realized by the CPU 201 executing a computer program recorded on a recording medium such as the ROM 202, the RAM 203, the HD 205, and the FD 207 shown in FIG. 2, and a function of outputting the information generated is realized by the I/F 209.

The storage device 306, specifically, is formed with the ROM 202, the RAM 203, the HD 205, the FDD 206, or the FD 207 shown in FIG. 2. The I/O device 307, specifically, is formed with the keyboard 210, the mouse 211, the scanner 212, and the printer 213 shown in FIG. 2.

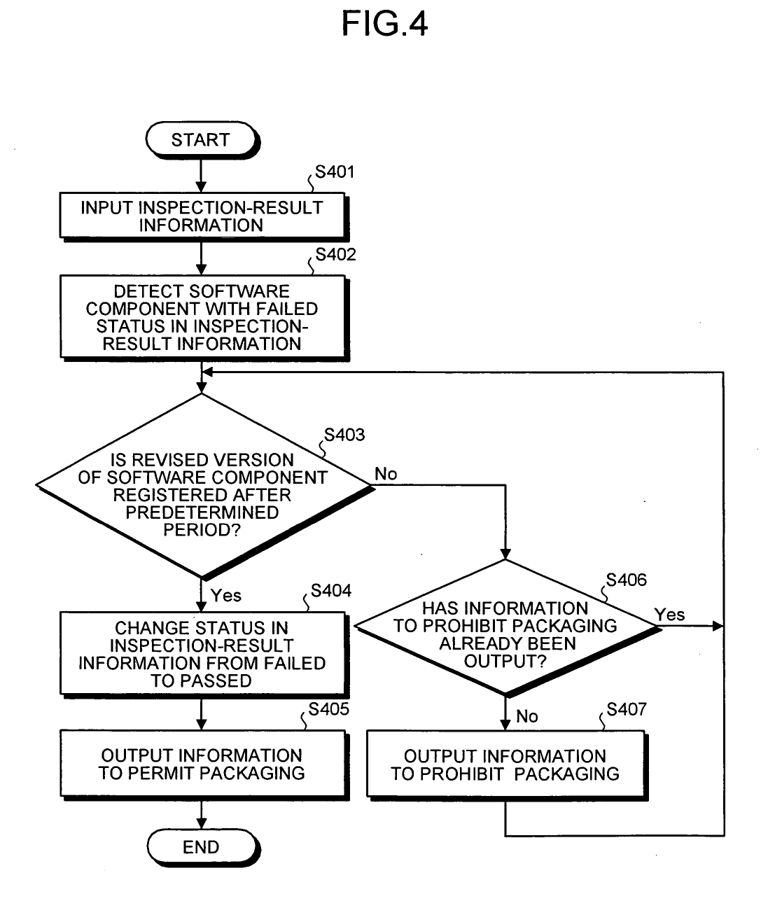

FIG. 4 is a flowchart of the software management process according to an embodiment of the present invention. As shown in FIG. 4, the receiving unit 301 receives the inspection-result information input by operating the I/O device 307 (step S401).

On receiving the inspection-result information, the detecting unit 302 detects software component that has failed in the inspection based on the inspection-result information (step S402). When the software component that has failed in the inspection is detected, the determining unit 303 determines whether a revised version of the software component detected is registered after the predetermined period (step S403).

If the determining unit 303 determines that the revised version is registered (“Yes” at step S403), the changing unit 304 changes a status indicated in the inspection-result information of the software component detected from the failed status to the cleared status (step S404). When the status is changed to cleared status, the output unit 305 outputs information indicating that the software components that correspond to the inspection-result information indicating that the software components have passed the inspection and the revised version may be packaged (step S405). Thus, the software management process is finished.

On the other hand, if the determining unit 303 determines that the revised version is not registered (“No” at step S403), it is determined whether the output unit 305 has already output information indicating that the software components may not be packaged (step S406). If it is determined that the output unit 305 has already output the information indicating that the software components may not be packaged (“Yes” at step S406), the process returns to step S403 to determine if a revised version has been registered.

If it is determined that the information indicating that the software components may not be packaged has not yet been output (“No” at step S406), the output unit 305 outputs information indicating that the software components may not be packaged (step S407). Then, the process returns to step S403 to determine if the revised version has been registered.

According to the embodiment of the present invention, even if one of plural software components registered in a predetermined period has failed in the inspection, and even if a revised version of the one is registered after the predetermined period, the software management system outputs information indicating that both software components that have passed the inspection and the revised version may be packaged. Thus, it is possible to perform packaging of software components efficiently and accurately. As a result, management of a software component regarding the packaging can be accomplished with ease and a work load on the management can be reduced.

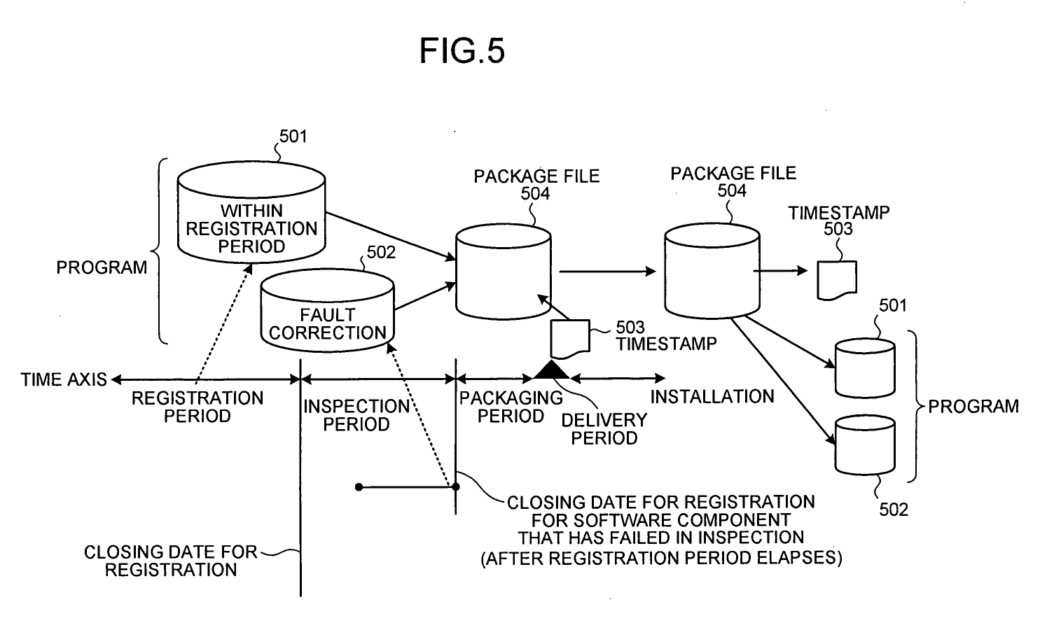

FIG. 5 is a schematic for illustrating a software-management time cycle of the software management system. An original software component 501 shown in FIG. 5 is a program registered in the software management system 100 in a predetermined period, which is a registration period until, for example, a closing data for registration shown in FIG. 5. A revised software component 502 is a program registered in the software management system 100 after a fault correction has been carried out during an inspection period (after the registration period has elapsed), which is a period from the closing date to a closing date for registration for a software component that has failed in the inspection.

In the software management system 100, a product in a form of a package file 504 is created during a packaging period by assigning a timestamp file 503 to both the original software component 501 and the revised software component 502. The package file 504 is zipped and made available to the users, which are the clients 102 to 105, for downloading over the network 106 during a delivery period. Each of the clients 102 to 105 extracts the package file 504 downloaded and installs the original software component 501 and the revised software component 502.

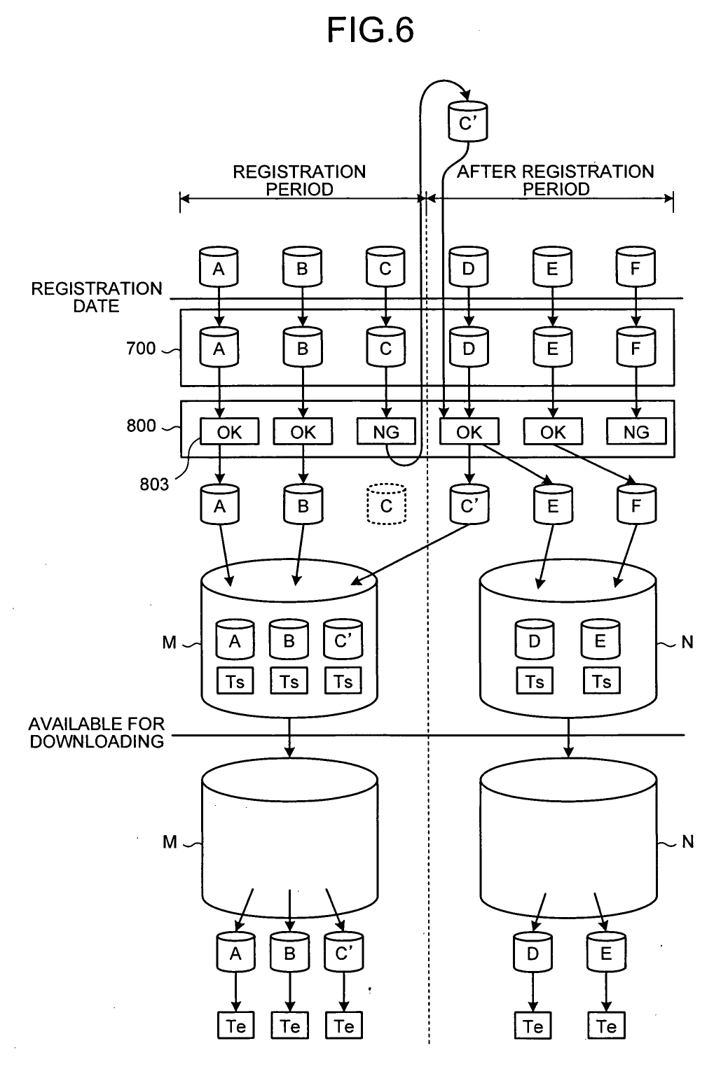

FIG. 6 is a schematic for illustrating an entire process of the software management process. As shown in FIG. 6, software components A to F are registered in the software management system 100 after a registration date. The software components A to C are registered within the registration period and the software components D to F are registered after the registration period. The registration period specifically refers to a fixed period from a starting date for registration, for example, “September 1, 2004”, to the closing date for registration, for example, “September 30, 2004”.

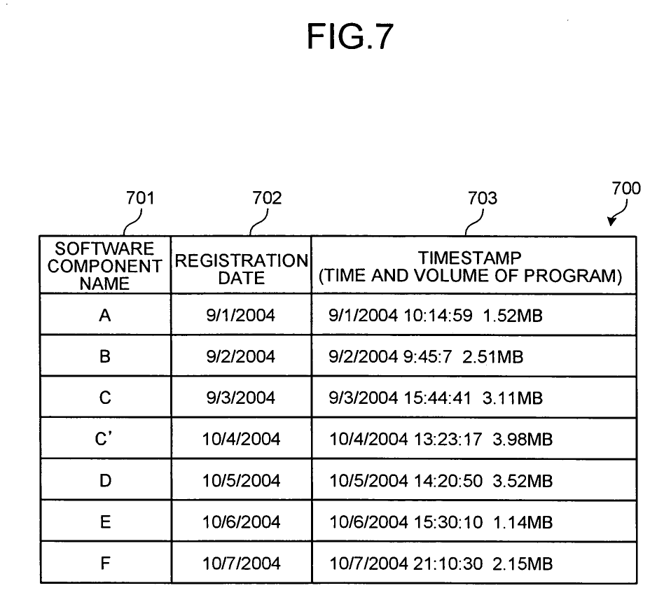

Information on registration of the software components A to F is managed in a time-cycle management table 700 in the software management system 100. FIG. 7 is a schematic for illustrating the time-cycle management table 700 used in the software management system. The software management server 101 includes the time-cycle management table 700. The time-cycle management table 700 stores information such as a software component name 701, a registration date 702, and a timestamp 703 that indicates time and volume of a program. The registration date 702 indicates a date of registration of the software components A to F. The timestamp 703 indicates a date of creation of the software components A to F.

As shown in FIG. 6, the receiving unit 301 receives inspection-result information 803 indicating whether each of the software components A to F has passed or failed in the inspection. On receiving the inspection-result information, the detecting unit 302 detects a software component that has failed in the inspection based on the inspection-result information. In an example shown in FIG. 6, the inspection-result information 803 of the software component C indicates the failed status. Thus, the detecting unit 302 detects the software component C that is then put through an error-correction process. A revised software component C′ created as a result of an error correction is registered (re-registered) in the software management system 100 after the registration period elapses.

When the revised software component C′ is registered, the determining unit 303 determines whether the revised software component C′ is registered after the registration period has elapsed. Since in the example shown in FIG. 6, the revised software component C′ is registered after the registration period has elapsed, the changing unit 304 changes the status of the revised software component C′ in the inspection-result information 803 from the failed status to the cleared status. Once the inspection-result information 803 of the revised software component C′ is changed, the inspection-result information 803 of each of the software components A to F is managed in a program-packaging management table 800.

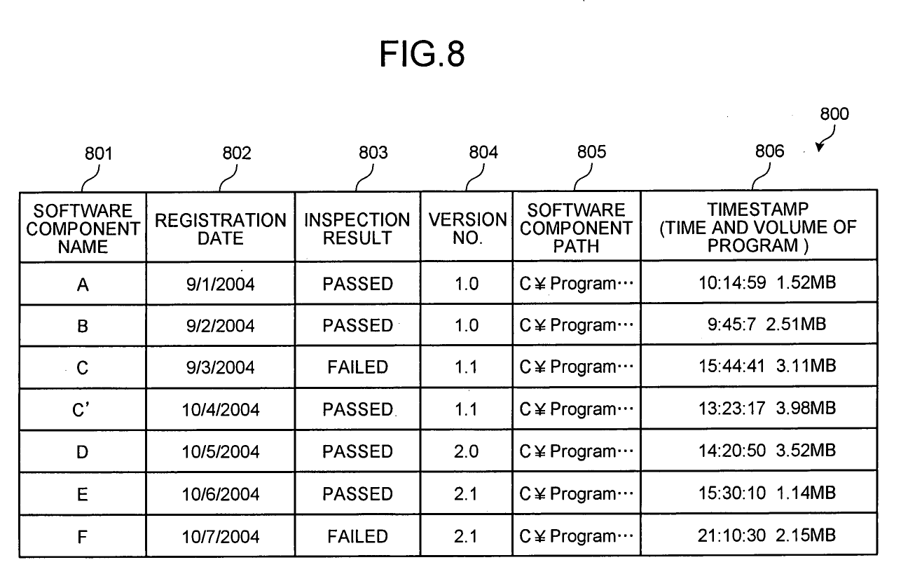

FIG. 8 is a schematic for illustrating the program-packaging management table 800 used in the software management system. The software management server 101 includes the program-packaging management table 800. The program-packaging management table 800 stores information such as a software component name 801, a registration date 802, the inspection-result information 803, a version number 804, a software component path 805, and a timestamp 806 indicating time and volume of a program. The version number 804 indicates a version number of the software components A to F. The software component path 805 indicates a folder in the clients 102 to 105 in which the program is installed.

Once the changing unit 304 changes the inspection-result information 803, the output unit 305 outputs information indicating that the software components A, B, D, and E, and the revised software component C′ for which the cleared status is indicated in the inspection-result information 803 may be packaged, based on the program-packaging management table 800. In the example shown in FIG. 6, the output unit outputs information indicating that the software components A, B, and C′ may be packaged to form a package file M to be packaged in the registration period, and the software components D and E may be packaged to form a package file N to be packaged after the registration period.

In other words, in the software management system 100, the output unit 305 outputs information indicating that packaging may be carried out based on not only the time-cycle management table 700 but also the program-packaging management table 800. Thus, determination on whether to package the software components is made not only based on the registration dates 702 and 802. Therefore, even if the revised software component C′, which is a revised version of the software component C that is supposed to be included in the package file M, is registered after the registration period, the revised software component C′ can be packaged in the package file M not in the package file N. Thus, the management of the software components A to F regarding packaging can be carried out easily and reliably.

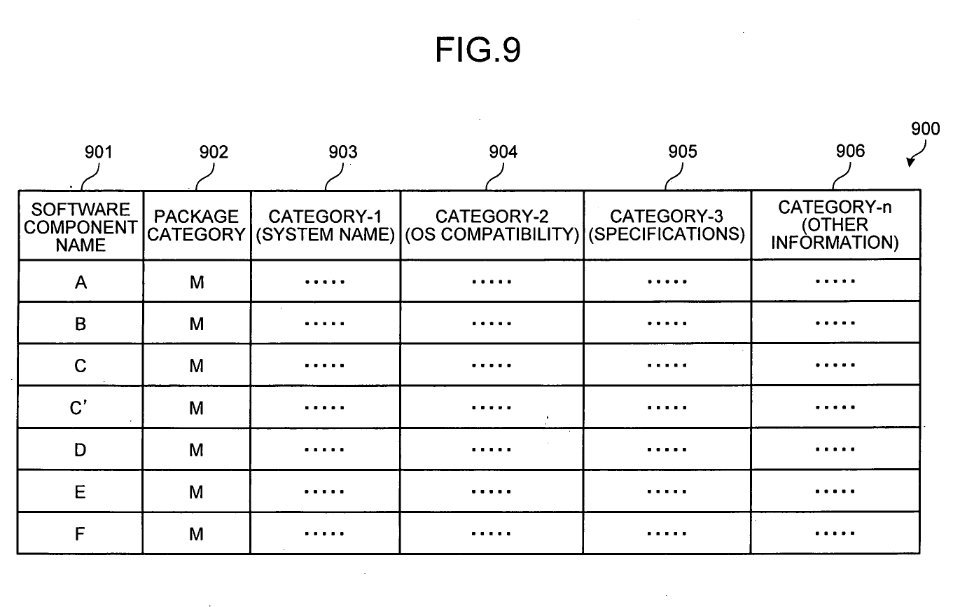

The information related to packaging may also be managed in a packaging-category management table 900 in the software management system 100. FIG. 9 is a schematic for illustrating the packaging-category management table 900 used in the software management system. The software management server 101 includes the packaging-category management table 900.

The packaging-category management table 900 stores information such as a software component name 901, a packaging category 902, and categories 1 to n (903 to 906). The category-1 (903) indicates, for example, a product model (system name) of the software components A to F, the category-2 (904) indicates an operating system (OS) with which each of the software components A to F is compatible, the category-3 (905) indicates specifications of the software components A to F, and the category-4 (906) indicates other information.

In the packaging-category management table 900, the software management server 101 classifies the software components A to F into categories 1 to n (903 through 906). Thus, the software management server 101 can output information for packaging for each of the categories. Consequently, category-wise package files M, and N can be created. Moreover, in the software management system 100, by providing a management table in which categories based on needs of the clients 102 to 105 and a correlation management table that manages correlation between the categories 1 to n and the package files M and N, it is possible to provide the package files M and N of categories that meet the needs of the clients 102 to 105.

When the information for packaging is output by the output unit 305, the package files M and N are created by, for example, an external device for creating a package as shown in FIG. 6. A timestamp file Ts is attached to each of the software components A to F in the package files M and N. The package files M and N are provided to the clients 102 to 105, for example, by downloading. At each of the clients 102 to 105, the package files M and N downloaded are expanded to install the software components A to F. The clients 102 to 105 extracts the timestamp files Ts from the package files M and N and stores the timestamp files Ts as timestamp files Te.

The software management server 101 determines whether the software components A to F downloaded are proper software components based on the timestamp files Ts that are attached to the software components A to F at the time of creation of the package files M and N and the timestamp files Te attached to the software components A to F at the time of installation. Besides the timestamp files Ts and Te, the software management server 101 determines whether the software components A to F downloaded are proper software components based on the time-cycle management table 700 and the program-packaging management table 800 by comparing information, such as the dates, the volume of a program, and the version number, of each of the software components A to F.

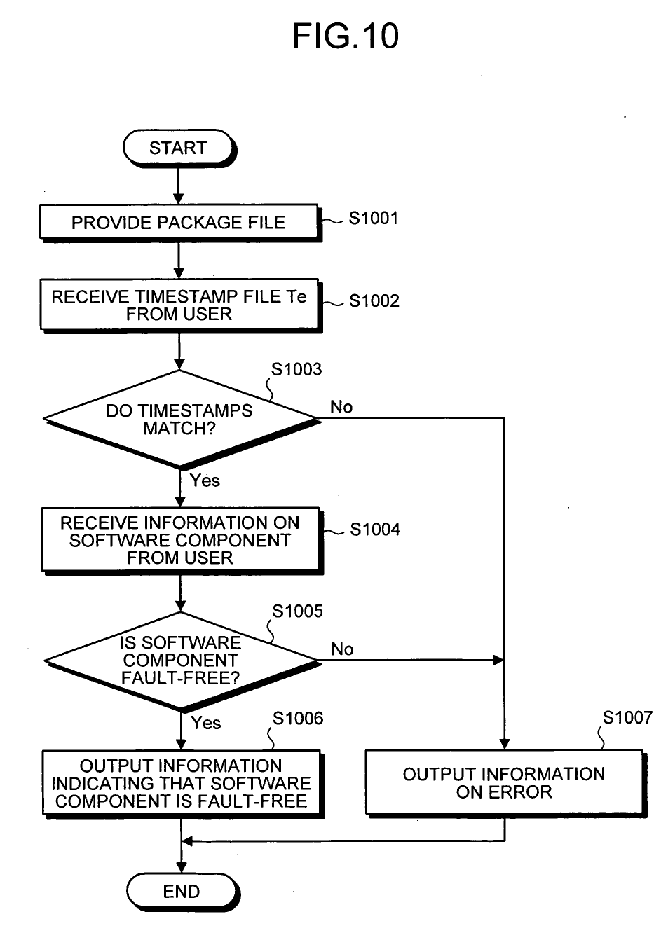

FIG. 10 is a flowchart of a program checking process according to the embodiment. The software management server 101 accepts the package file M and provides the package file M to the clients 102 to 105 (step S1001). Each of the clients 102 to 105 expands the package file M to installs the software components A, B, and C′.

After the software components A, B, and C′ are installed, the software management server 101 receives the timestamp files Te from the clients 102 to 105 over the network 106 (step S1002). The software management server 101 then determines whether timestamps in the timestamp files Te received and timestamps in the timestamp files Ts attached to the software components A, B, and C′ at the time of creation of the package file M match with each other (step S1003).

If the timestamps in the timestamp files Te and Ts match with each other (“Yes” at step S1003), the software management server 101 receives information on the software components A, B, and C′ from the clients 102 to 105 over the network 106 (step S1004). Based on the information on the software components A, B, and C′, the software management server 101 determines whether the software components A, B, and C′ installed are fault-free (step S1005). Whether the software components A, B, and C′ are fault-free is determined by comparing the version number, and the volume of a program of the software components A, B, and C′.

If the software components A, B, and C′ are determined to be fault-free (“Yes” at step S1005), the output unit 305 outputs information indicating that the software components A, B, and C′ are fault-free (step S1006), thus, finishing the program checking process. If it is determined that the timestamps do not match with each other (“No” at step S1003), and if at least one of the software components A, B, and C′ is determined to include a fault (“No” at step S1005), the output unit 305 outputs information on an error (step S1007), thus, finishing the program checking process.

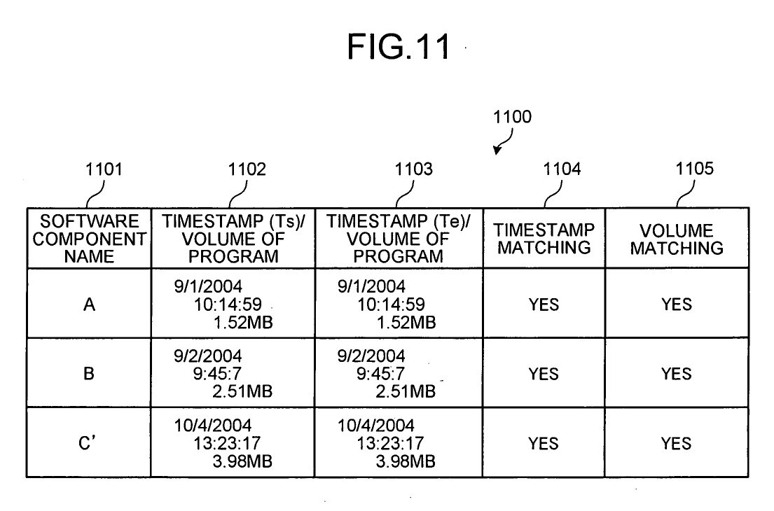

When the output unit 305 output information indicating that the software components A to F are fault-free at the end of program checking process (step S1006), a result of the program checking process is managed in a program-check-result management table in the software management server 101. FIG. 11 is a schematic for illustrating a program-check-result management table 1100 used in the software management system 100. The software management server 101 includes the program-check-result management table 1100. The program-check-result management table 1100 stores information such as a software component name 1101, a timestamp (Ts)/volume of a program 1102, a timestamp (Te)/volume of a program 1103, timestamp matching information 1104, and volume matching information 1105.

For example, the fields timestamp (Ts)/volume of a program 1102 and the timestamp (Te)/volume of a program 1103 have identical data for the software component A, that is “9/10/2004, 10:14:59, 1.52 Megabytes (MB)”. Thus, the timestamp matching information 1104 and the volume matching information 1105 have positive values to indicate that the software component A is downloaded properly.

Thus, with the software management system, the software management method, and the computer product according to the embodiment of the present invention, software management for packaging software components can be accomplished with ease, and a work load of the software management can be reduced. Consequently, reliable management of software components can be easily and efficiently achieved.

The software management method that is explained in the embodiment of the present invention is implemented by executing a computer program prepared in advance by a computer, such as a personal computer and a workstation. The computer program is recorded on a computer-readable recording medium, such as the CD-ROM, the MO, and the DVD, and is executed by the computer reading out from the recording medium. The computer program may be a transmission medium that is distributed through a network such as the Internet.

According to the present invention, it is possible to achieve reliable management of software components easily and efficiently.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A software management system comprising:
a receiving unit that receives inspection information that indicates a result of inspection carried out on a plurality of software components registered within a predetermined period, the inspection information indicating whether each of the software components has passed or failed in the inspection;
a detecting unit that detects a software component that has failed in the inspection based on the inspection information from among the software components registered;
a determining unit that determines whether a revised version of the software component detected is registered after the predetermined period; and
an output unit that outputs information indicating that at least such software components are permitted to be packaged that correspond to inspection information indicating that the software components have passed the inspection, based on determination by the determining unit.

2. The software management system according to claim 1, further comprising a changing unit that changes, when the determining unit determines that the revised version is registered, the inspection information corresponding to the software component detected, to indicate that the software component detected has passed the inspection, wherein when the changing unit changes the inspection information, the output unit outputs information indicating that the revised version is permitted to be packaged as well as such software components that correspond to the inspection information indicating that the software components have passed the inspection.

3. The software management system according to claim 1, wherein the output unit outputs information indicating that the software components are prohibited to be packaged, when the determining unit determines that the revised version is not registered.

4. The software management system according to claim 2, wherein the output unit classifies the software components and the revised version into predetermined categories and outputs information indicating that packaging is permitted to be performed for each of the categories.

5. A software management method comprising:
receiving inspection information that indicates a result of inspection carried out on a plurality of software components registered within a predetermined period, the inspection information indicating whether each of the software components has passed or failed in the inspection;
detecting a software component that has failed in the inspection based on the inspection information from among the software components registered;
determining whether a revised version of the software component detected is registered after the predetermined period; and
outputting information indicating that at least such software components are permitted to be packaged that correspond to inspection information indicating that the software components have passed the inspection, based on determination at the determining.

6. The software management method according to claim 5, further comprising changing, when it is determined that the revised version is registered at the determining, the inspection information corresponding to the software component detected, to indicate that the software component detected has passed the inspection, wherein
when the inspection information is changed at the changing, the outputting includes outputting information indicating that the revised version is permitted to be packaged as well as such software components that correspond to the inspection information indicating that the software components have passed the inspection.

7. The software management method according to claim 5, wherein the outputting includes outputting information indicating that the software components are prohibited to be packaged, when it is determined that the revised version is not registered at the determining.

8. The software management method according to claim 6, wherein the outputting further includes
classifying the software components and the revised version into predetermined categories, and
outputting information indicating that packaging is permitted to be performed for each of the categories.

9. A computer-readable recording medium that stores a software management program, the software management program making a computer execute:
receiving inspection information that indicates a result of inspection carried out on a plurality of software components registered within a predetermined period, the inspection information indicating whether each of the software components has passed or failed in the inspection;
detecting a software component that has failed in the inspection based on the inspection information from among the software components registered;
determining whether a revised version of the software component detected is registered after the predetermined period; and
outputting information indicating that at least such software components are permitted to be packaged that correspond to inspection information indicating that the software components have passed the inspection, based on determination at the determining.

10. The computer-readable recording medium according to claim 9, wherein
the software management program further makes the computer execute changing, when it is determined that the revised version is registered at the determining, the inspection information corresponding to the software component detected, to indicate that the software component detected has passed the inspection, and
when the inspection information is changed at the changing, the outputting includes outputting information indicating that the revised version is permitted to be packaged as well as such software components that correspond to the inspection information indicating that the software components have passed the inspection.

11. The computer-readable recording medium according to claim 9, wherein the outputting includes outputting information indicating that the software components are prohibited to be packaged, when it is determined that the revised version is not registered at the determining.

12. The computer-readable recording medium according to claim 10, wherein the outputting further includes
classifying the software components and the revised version into predetermined categories, and
outputting information indicating that packaging is permitted to be performed for each of the categories.
